(19) United States
(12) Patent Application Publication
(10) Pub. No.: US 2003/0214805 A1
(43) Pub. Date: Nov. 20, 2003

(54) ARTIFICIAL CHRISTMAS TREE

(76) Inventors: Jen-Fu Chen, Feng Yuan City (TW); Chih-Shen Chen, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/144,896

(22) Filed: May 14, 2002

(51) Int. Cl. F21V 9/16; A41G 1/00

(52) U.S. Cl. 362/84; 428/7; 428/20; 362/123; 362/806; 362/807

(57) ABSTRACT

An artificial Christmas tree includes a base, a trunk mounted on the base and at least one branch mounted on the trunk. The at least one branch includes a luminescent strip and a plurality of artificial leaves formed on the luminescent strip. The trunk may include at least one socket formed thereon. The luminescent strip may include a plug formed at an end thereof for engagement with the at least one socket formed on the trunk. The luminescent strip may include a socket formed thereon for engagement with a plug of a luminescent decoration. The base may include a circuit board mounted thereon. The artificial Christmas tree may include a speaker in electric connection with the circuit board. The base may include a socket formed thereon in electric connection with the circuit board. The trunk may include a plug formed at a lower end thereof for engagement with the socket formed on the base. The trunk may include a luminescent layer coated thereon.

### BACKGROUND OF INVENTION

1. Field of Invention

The present invention is related to an artificial Christmas tree.

2. Related Prior Art

Christmas has become an important holiday in many countries. A lot of people even non-Christians celebrate Christmas. Christmas trees are representative decorations in Christmas. Some people take natural pine trees for Christmas trees, other people turn to artificial Christmas trees.

Taiwanese Patent Publication No. 350277 discloses an artificial Christmas tree with a base, a trunk mounted on the base and many branches mounted on the trunk. Many light bulbs are mounted on each of the branches. In operation, the large amount of light bulbs require a strong current of electricity for a long period of time and may cause a cable for transmitting the current of electricity to melt. Furthermore, the light bulbs can be broken easily, thus causing danger.

The present invention is therefore intended to obviate or at least alleviate the problems encountered in prior art.

### SUMMARY OF INVENTION

It is an objective of the present invention to provide an artificial Christmas tree that requires a small current of electricity for luminescence.

It is another objective of the present invention to provide an artificial Christmas tree with a light source that is strong in structure.

It is another objective of the present invention to provide an artificial Christmas tree with which various luminescent decorations can be engaged.

It is another objective of the present invention to provide an artificial Christmas tree capable of providing music.

According to the present invention, an artificial Christmas tree includes a base, a trunk mounted on the base and at least one branch mounted on the trunk. The at least one branch includes a luminescent strip and a plurality of artificial leaves formed on the luminescent strip.

The trunk may include at least one socket formed thereon. The luminescent strip may include a plug formed at an end thereof for engagement with the at least one socket formed on the trunk.

The luminescent strip may include a socket formed thereon for engagement with a plug of a luminescent decoration.

The base may include a circuit board mounted thereon.

The artificial Christmas tree may include a speaker in electric connection with the circuit board.

The base may include a socket formed thereon in electric connection with the circuit board. The trunk may include a plug formed at a lower end thereof for engagement with the socket formed on the base.

The trunk may include a luminescent layer coated thereon.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of an artificial Christmas tree according to the present invention including a base, a trunk, branches and star-shaped decorations;

FIG. 2 is an exploded view of the artificial Christmas tree shown in FIG. 1 but only showing one of the branches and one of the star-shaped decorations;

FIG. 3 shows in a great scale the star-shaped decoration and the branch shown in FIG. 2; and

FIG. 4 shows the star-shaped decoration engaged with the branch engaged with the trunk shown in FIG. 2.

### DETAILED DESCRIPTION OF PREFERRED EMBODIMENT

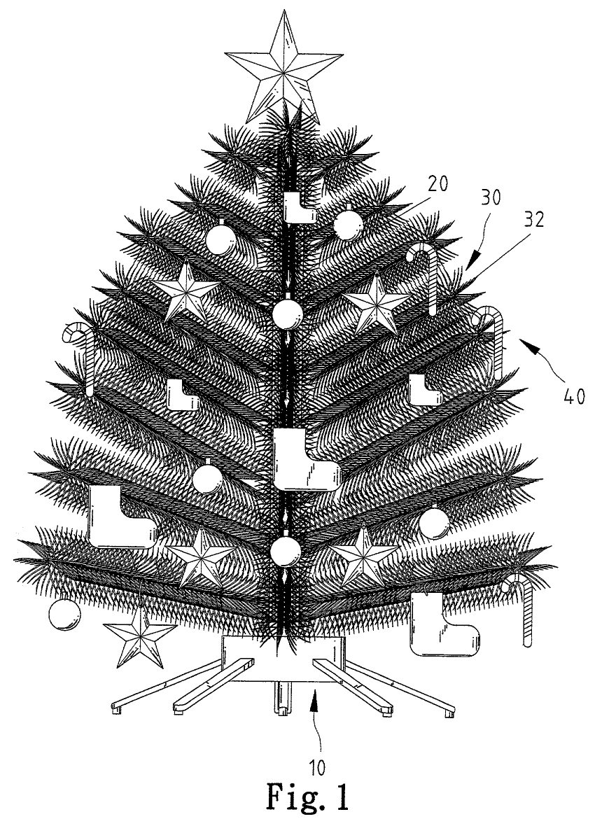

Referring to FIG. 1, an artificial Christmas tree according to the preferred embodiment of the present invention includes a base 10, a trunk 20 mounted on the base 10 and a plurality of branches 30 mounted on the trunk 20. Some star-shaped luminescent decorations 40 can be mounted on some or all of the branches 30.

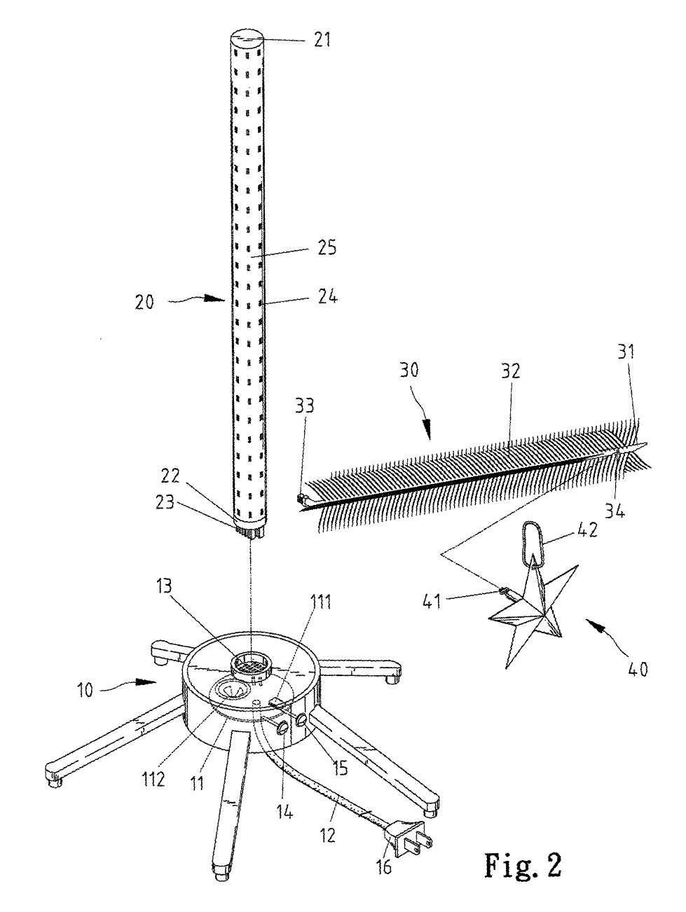

The artificial Christmas tree will be described in detail further referring to FIGS. 2-4 that only show one of the branches 30 and one of the star-shaped decorations 40.

Referring to FIG. 2, the base 10 defines a space (not numbered) in which a circuit board 11 is installed. A wire 12 includes a first end in electric connection with the is circuit board 11 and a second end formed with a plug 16. The wire 12 leads from the circuit board 11 to the exterior of the base 10 through an aperture (not shown) defined in the base 10. On the base 10 is mounted a socket 13 in electric connection with the circuit board 11. A central processor unit (“CPU”) 111 and a speaker 112 are mounted on the circuit board 11. On the base 10 are mounted a switch 14 and a function button 15 both in electric connection with the circuit board 11.

The trunk 20 includes an upper end 21 and a lower end 22. A plug 23 is formed at the lower end of the trunk 20. On the trunk 20 are formed a plurality of sockets 24 in electric connection with the plug 23. The trunk 20 is coated with a luminescent layer 25 in electric connection with the plug 23.

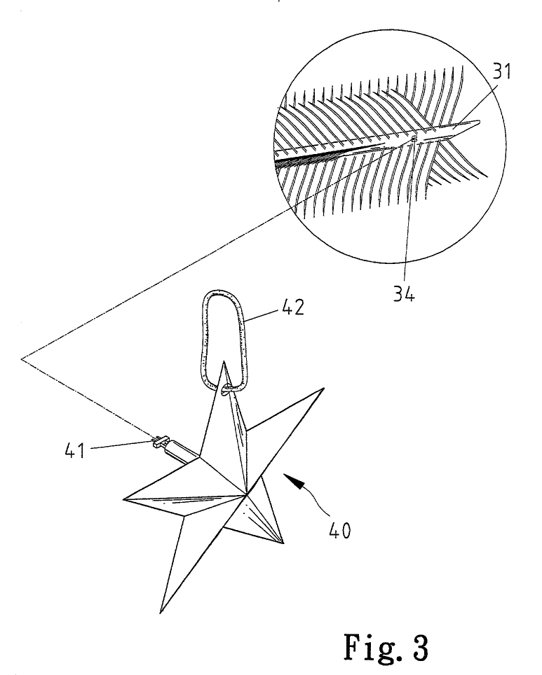

The branch 30 includes a luminescent strip 31, a plurality of leaves 32 formed on the luminescent strip 31, a plug 33 formed at a first end of the luminescent strip 31 and a socket 34 formed near a second end of the luminescent strip 31 as best shown in FIG. 3.

The star-shaped luminescent decoration 40 includes a plug 41 formed thereon as best shown in FIG. 3. A loop 42 is tied to the star-shaped luminescent decoration 40.

In assembly, the lower end 22 of the trunk 20 is mounted on the base 10 so that the plug 23 is engaged with the socket 13. The plug 33 is engaged with one of the sockets 24, thus mounting the branch 30 on the trunk 20. The loop 42 is put around the second end of the luminescent strip 31, thus attaching the star-shaped luminescent decoration 40 to the branch 30. The plug 41 is engaged with the socket 34.

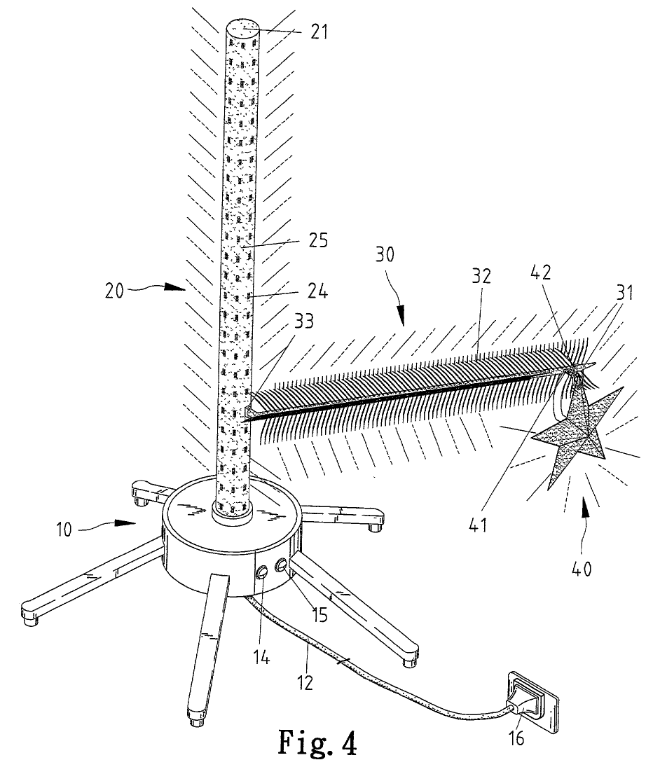

Referring to FIG. 4, the plug 16 is engaged with a socket (not numbered) for input of electricity to the artificial Christmas tree. Thus, the luminescent layer 25, the luminescent strip 31 and the star-shaped luminescent decoration 40 illuminate.

The artificial Christmas tree provides several advantageous features. Firstly, each branch 30 includes only one luminescent strip 31 that requires a small current of electricity. Secondly, the luminescent strips 31 are strong in structure. Thirdly, due to the use of the sockets 34, various luminescent decorations can be used. Fourthly, due to the use of a music synthesizer and in the circuit board 11 and the speaker 112 various sorts of music are available.

The present invention has been described through detailed illustration of the preferred embodiment thereof. Those skilled in the art can derive many variations from the preferred embodiment without departing from the scope of the present invention. Therefore, the preferred embodiment shall not limit the scope of the present invention. The scope of the present invention is defined in the attached claims.

1. An artificial Christmas tree including a base (10), a trunk (20) mounted on the base (10) and at least one branch (30) mounted on the trunk (20), wherein the at least one branch (30) includes a luminescent strip (31) and a plurality of leaves (32) formed on the luminescent strip (31).

2. The artificial Christmas tree according to claim 1 wherein the tunk (20) includes at least one socket (24) formed thereon and the luminescent strip (31) includes a plug (33) formed at an end thereof for engagement with the at least one socket (24) formed on the trunk (20).

3. The artificial Christmas tree according to claim 1 wherein the luminescent strip (31) includes a socket (34) formed thereon for engagement with a plug (41) of a luminescent decoration (40).

4. The artificial Christmas tree according to claim 1 wherein the base (10) includes a circuit board (11) mounted thereon.

5. The artificial Christmas tree according to claim 4 including a speaker (112) in electric connection with the circuit board (11).

6. The artificial Christmas tree according to claim 4 wherein the base (10) includes a socket (13) formed thereon in electric connection with the circuit board (11) and the trunk (20) includes a plug (23) formed at a lower end thereof for engagement with the socket (13) formed on the base (10).

7. The artificial Christmas tree according to claim 1 wherein the trunk (20) includes a luminescent layer 25 coated thereon.
